(19) United States
(12) Patent Application Publication
(10) Pub. No.: US 2002/0144684 A1
(43) Pub. Date: Oct. 10, 2002

(54) BI/PAP mask for sleep apnea and other related clinical uses

(76) Inventor: Samuel Joseph Moone, Pickerington, OH (US)

Correspondence Address: Samuel Joseph Moone, 13450 Falmouth Ave., Pickerington, OH, 43147, US

(21) Appl. No.: 09/849,917

(22) Filed: Apr. 6, 2001

(51) Int. Cl. A62B 18/08

(52) U.S. Cl. 128/206.24; 128/206.26

(57) ABSTRACT

The introduction of gas/air flow tubes molded/inserted from the top gas/air flow channel to the front area below the nasal area will generate additional air flow to the user's nose below the nasal openings. The gas/air flow tubes will allow users of breathing masks to become accustomed to masks that will be providing gas/air for various purposes. In this instance the mask will be providing comforting simulated breathing for a BIPAP user with sleep apnea, eliminating the feeling of insufficient airflow to the nasal area. This will eliminate user discomfort with current masks that cause discontinued cooperation by patients with the sleeping regimen. By inserting a plug in the bottom of the gas/air flow tube top the mask will convert from a BIPAP mask, to a CPaP mask. This mask can be used in a variety of hospital/healthcare settings where gas/air is used by patients.

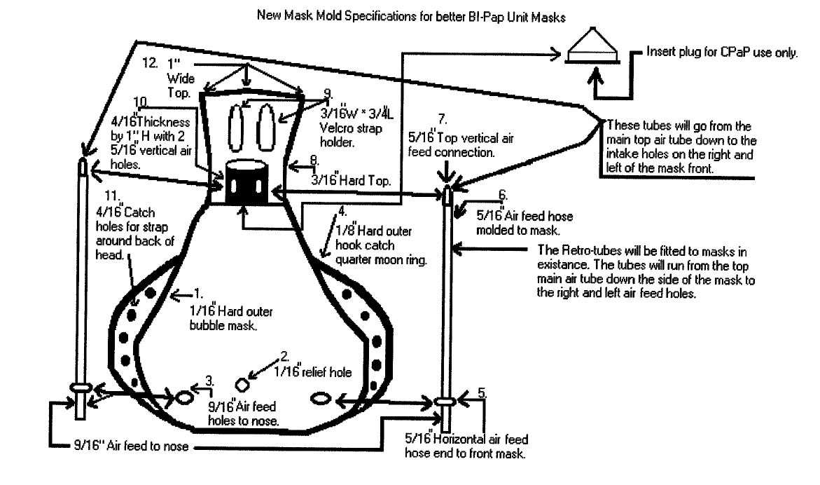

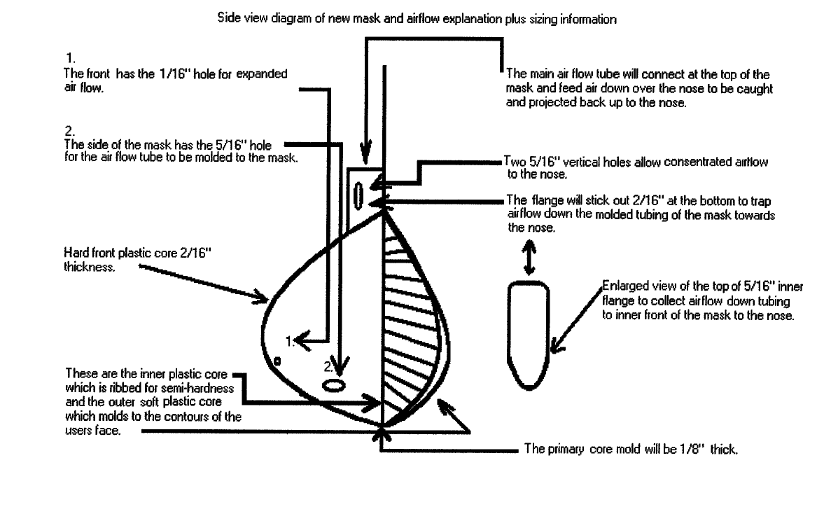

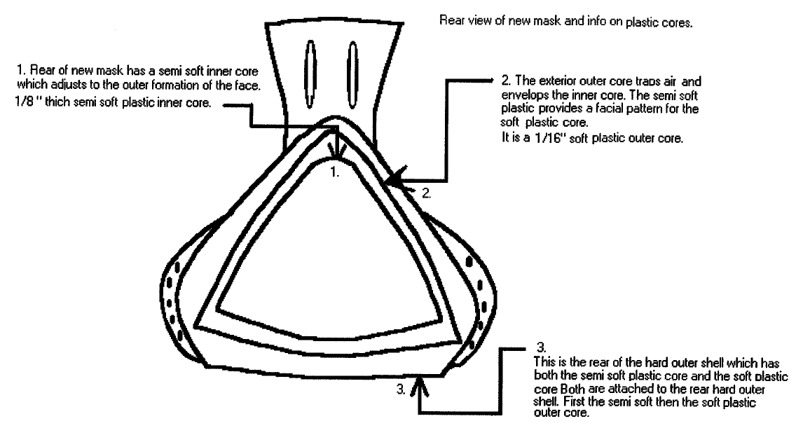

### BACKGROUND OF THE INVENTION

A variety of respiratory masks are known which have flexible seals that cover the nose and/or mouth of a human user and are designed to create a continuous seal against the user's face.

Because of the sealing effect that is created, the user may provide gases/air at a positive/simulated breathing pressure within the mask for consumption. The uses for such a mask would range from high altitude breathing (i.e., aviation applications) to mining and fire fighting applications, to various medical diagnostic and therapeutic applications.

One requisite of such respiratory masks has been that they provide an effective seal against the user's face to prevent leakage of the gas/air being supplied. Commonly, in mask configurations, a good mask-to-face seal has been attained in many instances only with considerable discomfort for the user. This problem is most crucial in those applications, especially medical applications, which require the user to wear such a mask continuously for hours or perhaps even days. In such situations, the user will not tolerate the mask for long duration's and optimum therapeutic or diagnostic objectives thus will not be achieved, or will be achieved with great difficulty and considerable user discomfort.

The most common type of mask incorporates a smooth sealing surface extending around the periphery of the mask and exhibiting a generally uniform (i.e., predetermined or fixed) seal surface contour which is intended to be effective to seal against the user's face when force is applied to the mask with the smooth sealing surface in confronting engagement with the user's face. The sealing surface may consist of an air or fluid filled cushion, or it may simply be a molded or formed surface of a resilient seal element made of elastic such as plastic or possibly made of rubber. Such masks have performed well when the fit is good between the contours of the seal surface and the corresponding contours of the user's face. However, if the seal fit is not good, there will be gaps in the seal-to-face interface and excessive force will be required to compress the seal member.

Such excessive force is unacceptable as it produces high pressure points elsewhere on the face of the user where the mask seal contour is forcibly deformed against the face to conform to the user's facial contours. Ideally, contact forces should be limited between the mask and the user's face to avoid exceeding pressure even at points where the mask seal must deform considerably. The problem of seal contact force exceeding desirable limits is even more pronounced when the positive pressure of the gas/air being supplied is relatively high or is pulsating to high levels. Since the mask seals by virtue of confronting contact between the mask seal and the user's face, the mask must be held against the face with a force sufficient to seal against leakage of the peak pressure of the supplied gas/air. Thus, for conventional masks, when the supply pressure is high, headstraps or other mask restraints must be tightly fastened. This produces high-localized pressure on the face, not only in the zone of the mask seal but at various locations along the extent of the retention straps as well. This will result in severe discomfort for the user after only a brief time. Even in the absence of excessive localized pressure points, the tight mask and headstraps often may become extremely uncomfortable and user discomfort may well cause discontinued cooperation with the regimen.

A second type of mask, which has been used with a measure of success, incorporates a flap seal of thin material so positioned about the periphery of the mask as to provide a self-sealing action against the face of the user when positive pressure is applied within the mask. In such a mask, the flap seal typically defines a contoured sealing surface adapted for confronting and sealing engagement with the user's face. Under the influence of a flow of pressurized gas/air supplied to the interior of the mask that impinges upon the surface opposite the contoured sealing surface, the sealing surface is urged into sealing contact with the user's face. With this type of sealing action, the forces, which serve to hold the mask in confronting engagement on the face of the user, are much lower than with the first type of mask described above. If the flap seal is capable of conforming to the contours of the user's face without forming leak paths, the mask can be used with retention straps, which exert little or no net force to push the mask against the user's face. Thus, the overall sensation of constraint and confinement is dramatically reduced for the user. Such a mask, when properly adjusted, can be adapted to any positive internal mask pressure. The sealing flap will be self-sealing as long as there is no looseness in the strapping arrangement that would allow the mask to move away from the face further than the reach of the sealing flap when subjected to internal pressure.

Among the potential limitations of the second described masked type is two of note. First, the sealing flap seals by lying flat against the user's face throughout its length. This action requires a close match between the contours of the face and those of the seal. If the match is not good, the seal will be ineffective. Secondly, the normal response of one applying the mask to a user's face is to push the mask harder against the user's face if the mask does not seal. With the typical flap seal-type mask, increasing contact pressure against the user's face will not help to form an effective seal if the flap seal does not initially fit well to the facial contours. It may, however, lead to patient discomfort and other problems as described above.

Some principal problems one encounters when trying to apply the self-sealing flap concept to the design of the respiratory mask are related to the location of relative low and high points in the facial contours of the user relative to the shape or contour of the flap seal surface. If the seal surface does not contact the user's face at the relative lower points, then excessive gas/air leakage will occur thus preventing sufficient internal gas/air pressure to develop to activate the sealing action of the seal flap at the low points. This problem has been solved for some applications by providing a variety of masks with differing seal flap shapes, sizes and contours. For example, for aircraft breathing masks, especially where expense is not a critical factor, wide variety of mask shapes and sizes may be provided to give the individual users an opportunity to find a mask offering good fit. In other breathing mask applications such as clinical use, where economic considerations may dictate a mask having the capability to accommodate a wide variety of facial sizes and contours, prior flap type seal structures have not generally been able to provide the requisite versatility. A related problem with flap seal mask structures concerns the high points of the user's face, where the seal flap may tend to distort or collapse and fold in on itself. This creates a channel for gas/air leakage, when pressure is applied in order to effect a seal at adjacent relative low points on the user's face. Even where the section thickness of the seal flap is very thin, and the material is very soft and flexible, the internal gas/air pressure cannot overcome some such seal flap distortion to provide the desired self-sealing.

The desired mask includes a generally annular seal comprised of a peripheral sidewall having an inturned flexible flap seal adjacent a free end thereof, with the inturned seal being configured for confronting sealing engagement with a user's face as above described. Spaced about the peripheral seal wall are plural, upstanding, flexible ribs which serve to support the outer peripheral wall and an inturned portion of the seal member located generally outward of the face-engaging surface portion of the seal flap. The described seal structure is intended to permit the flap seal and peripheral outer sidewall to distort without experiencing any mode of seal defeating deformation such as crimping, buckling, folding or other modes of collapse. In this seal structure, the structural support ribs are located and configured in a manner to provide adequate seal flap support where seal deformation is not required, at the “low” points of the contours of the user's face, and to resiliently deform in a manner to permit easy and uniform distortion of the seal flap in those areas where distortion is necessary to accommodate “high” points on the contours of the user's face.

Other respiratory masks having flexible flap facial seats are disclosed in U.S. Pat. Nos. 4,167,185 and 4,677,977. Masks comprising continuous cushion and flexible flap sealing features are described in U.S. Pat. Nos. 2,931,356, 3,330,273, and 4,971,051.

Despite its general efficacy in affording a desired seal against the typical user's face, the construction of the inturned flexible flap is such that the contours of certain users' faces may preclude reliable sealing by masks of this type. In this regard, the seal flap includes an opening having an enlarged lower portion to accommodate lower regions of the user's nose (and possibly the user's upper mouth) and an upwardly extending narrow slot portion adapted to receive the bridge of the nose. The slot divides the flap into a pair of opposed flap portions adapted to lie against opposite sides of the user's nose during use. However, the front portion of the nose is left uncovered and shape of the user's nose may be such that is does not mate particularly well with the slot. For instance, the flap portions may not fully contact the sides of the user's nose or may be excessively displaced thereby which, in either case, may result in leaks in the flexible seal in the region of the nasal flap portions. These leaks will be temporary in nature since the mask has to conform to the user's facial contour and then any leaks will be negligible in the near future.

### SUMMARY OF NEW MASK INCLUSIONS

The primary introduction of gas/air flow tubes molded from the top gas/air flow channel to the front area below the nasal area will help to generate additional air flow to the user's nose directly below the nasal openings. These gas/air flow tubes will allow the new/veteran user of breathing masks to become accustomed to using the masks that will be providing gas/air for various purposes. In this instance the mask will be providing comforting simulated breathing for a BI/PAP user which has sleep apnea, eliminating the feeling of insufficient airflow to the nasal area. This will help to eliminate the user discomfort intregal with current BI/PAP masks that will cause discontinued cooperation with the sleeping regimen. This new mask will incorporate the features in the secondary mask page 3 * and have small, medium, and large sized masks created for the difference in the facial contours of individuals. The introduction of a insertion plug for the bottom of the gas/air flow tube top will convert the mask from a BI/PAP mask, to a CPaP mask, thereby eliminating the need to purchase an additional mask, if the user is downgraded to a CPaP mask. This mask will also have the ability to be used in a variety of hospital/healthcare settings where gas/air is used by patients with breathing problems, or the need to be on constant/simulated breathing patterns for any length of time.

### Retrofit Airflow Tubes

The secondary introduction of retrofit airflow tubes that will be created for BI/PAP masks in existence will include the ability to create holes in the upper air chamber tube 5/16″ diameter and holes created in the right/left sides of existing BI/PAP masks 5/16″ diameter. The holes in the front of the mask under the nasal area will accommodate the new inner semi-soft tube 9/16″ length. These tubes will be placed through the newly created holes and adhered to the inside of the hard outer front shell and top gas/air feed induction gas/air feed tube holder.

### DESCRIPTION OF CLAIMED INVENTION

A flexible, resilient respiratory mask facial seal adapted for confronting engagement with the face of a user to form an orbicular sealed interface encompassing a predetermined portion of the user's face. The facial seal includes a peripheral wall and an inturned flap seal. The flap seal projects radially inwardly of the outer wall and defines a contoured sealing surface adapted for confronting and sealing engagement with the user's face. The flap seal includes a second recessed area corresponding substantially in the shape to a human nose for continuously and matingly conforming to the front and side contours of the user's nose when the facial seal is brought into meeting engagement with the user's face. The second inner recessed flap seal area will have vertical and horizontal ribs, which will provide stabilization to the inner seal, for formation around the nose and users facial features. The addition of molded airflow tubes to the lower nasal portion of the mask is to provide additional gas/air flow to the user's nose. These additional gas/air tubes will provide comforting flow of simulated breathing gas/air pressure, which will enhance the user's ability to adapt to constant long-term usage of the mask.

What is claimed:

1. A flexible, resilient respiratory mask facial seal adapted for confronting engagement with a face of a human user to form an spherical sealed interface encompassing a predetermined portion of a user's face, said facial seal being adapted for operative connection to a source of breathing gas/air and comprising:
a peripheral wall portion having an inverted bulb-shaped inner end and an outer end opposite said inner end;
a generally inverted bulb-shaped inturned flap seal portion integral with said peripheral wall portion and located adjacent said outer end, said flap seal portion projecting radially inwardly of said peripheral wall portion and defining a contoured sealing surface adapted for confronting and sealing engagement with said predetermined portion of a user's face, said flap seal portion further defining a surface opposite said contoured sealing surface against which a flow of breathing gas/air delivered from a breathing gas/air source urges said contoured sealing surface into said confronting and sealing engagement with said predetermined portion of a user's face; and
means formed in said flap seal portion for continuously and matingly conforming to the front and side contours of a nose of a user responsive to a breathing gas/air flow against said surface opposite said contoured sealing surface, said means for matingly conforming comprising a recessed area integral and contiguous with said flap seal portion and corresponding substantially in shape to that of a human nose.
